(19) United States
(12) Patent Application Publication
(10) Pub. No.: US 2010/0134277 A1
(43) Pub. Date: Jun. 3, 2010

(54) SYSTEM AND METHOD FOR TRANSMITTING AND RESPONDING TO AN EMERGENCY SIGNAL

(75) Inventor: Jin-Tae JANG, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/614,575

(22) Filed: Nov. 9, 2009

(30) Foreign Application Priority Data
Nov. 28, 2008 (KR) 10-2008-0119526

(51) Int. Cl. G08B 1/08

(52) U.S. Cl. 340/539.13; 340/539.11

(57) ABSTRACT

A system and a method for transmitting and responding to an emergency signal are provided. In the system, when a user facing an emergency situation presses an emergency signal button of a mobile terminal, an emergency signal is transmitted to a security unit provided with alarm apparatuses such as flashing lights and sirens. The security unit that has received the emergency signal operates the alarm apparatuses, and simultaneously, transmits an emergency situation occurrence signal to a security center, so that a staff member located closest to an occurrence area of the emergency situation may intercept to prevent the crime.

### PRIORITY

This application claims the benefit under 35 U.S.C.§119(a) of a Korean patent application filed in the Korean Intellectual Property Office on Nov. 28, 2008 and assigned Serial No. 10-2008-0119526, the entire disclosure of which is hereby incorporated by reference.

### BACKGROUND OF THE INVENTION

1. Field of the Invention

The present invention relates to an emergency rescue system and a method thereof which operates with a mobile terminal. More particularly, the present invention relates to a system and a method in which a mobile terminal sends an emergency signal to a neighboring security unit, that in response operates flashing lights and a siren, and informs a security center of the emergency situation that informs a staff member of the emergency situation.

2. Description of the Related Art

A conventional mobile communication terminal is a generic term for mobile phones, palm sized Personal Computers (PCs), Personal Digital Assistants (PDAs), Hand-held PCs (HPCs), and the like. The conventional mobile communication terminal denotes a communication apparatus which can perform various functions using a network access as well as wireless communication without location being a limitation.

In a modern environment where threats of various crimes increase more and more, there are weapons for self-defense such as a conventional firearm and an electric shock unit, but it is difficult for people to carry one of those weapons with them due to the weapons shape or size, and thus those weapons are not widely used. If a function for self-defense is added to a mobile terminal which is ubiquitous and can be easily carried and used by anybody, it is expected that a crime rate will be reduced.

In a conventional mobile terminal, an SOS function, namely a function of, when an emergency situation occurs, transmitting a short message to a number designated in advance for informing a police station, a fire station, or the like of the emergency situation has been realized. However, this function is not widely used and even when an emergency situation message is received, the message is ignored, or a receiver who has received the message has a limitation in taking a measure for preventing a crime. Accordingly, there is an effort to add to a mobile terminal itself a function of ringing an alarm. However, the alarm is limited in its sound. Also, when a criminal captures and destroys a mobile terminal, usefulness of this method is diminished.

### SUMMARY OF THE INVENTION

An aspect of the present invention is to address at least the above-mentioned problems and/or disadvantages and to provide at least the advantages described below. Accordingly, an aspect of the present invention is to provide a system and a method for responding to an emergency signal transmitted by a user of a mobile terminal.

In accordance with an aspect of the present invention, a method for transmitting and responding to an emergency signal is provided. The method includes, determining, by the mobile terminal, whether an emergency key that indicates the occurrence of an emergency situation is pressed, when it is determined that the emergency key is pressed, transmitting, by the mobile terminal, an emergency signal to a neighboring security unit via short range communication, receiving, by the neighboring security unit, the emergency signal from the mobile terminal via the short range communication, and operating an alarm apparatus according to the received emergency signal.

In accordance with another aspect of the present invention, a system for transmitting and responding to an emergency signal is provided. The system includes a mobile terminal and a security unit. The mobile terminal includes a key for indicating the occurrence of an emergency situation when it is pressed, a controller for determining if the key is pressed, and if it is determined that the key is pressed, for generating an emergency signal, and a short range communication unit for transmitting the emergency signal to the security company. The security unit includes a short range communication unit for receiving the emergency signal transmitted from the mobile terminal, a controller for operating an alarm apparatus according to the received emergency signal, and the alarm apparatus for executing an alarm operation.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

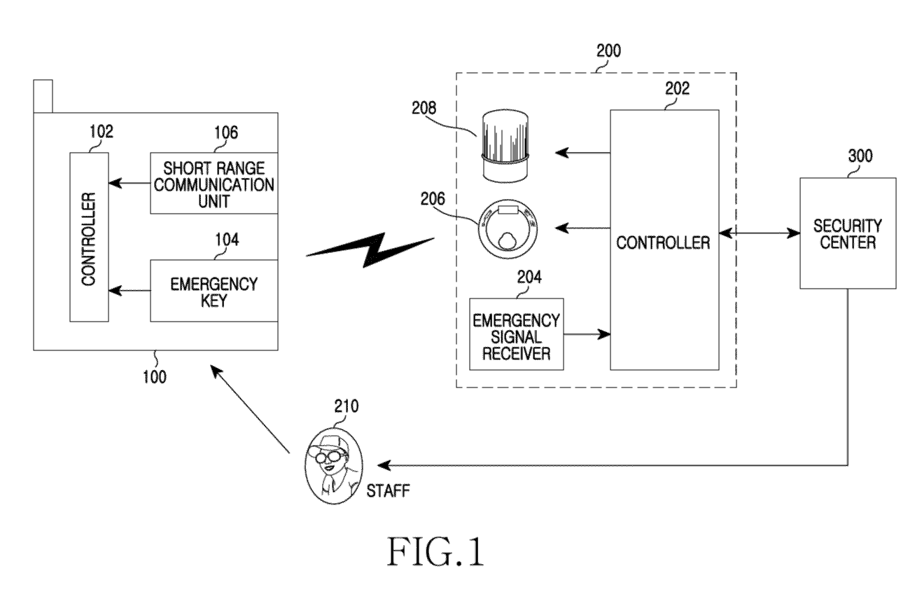

FIG. 1 is a view illustrating a system according to an exemplary embodiment of the present invention.

According to an exemplary embodiment of the present invention, a mobile terminal 100 includes an emergency key 104 that can be pressed when an emergency situation occurs, a controller 102 for generating an emergency signal, and a short range communication unit 106 for transmitting the emergency signal to a neighboring security unit 200. The security unit 200 includes an emergency signal receiver 204 for receiving a signal from the mobile terminal via short range communication, and a controller 202 for determining whether the received signal is an emergency signal, generating an emergency situation occurrence signal, transmitting the emergency situation occurrence signal to a security center 300, and driving an emergency alarm apparatus such as a siren 206 and a flashing light 208.

The security center 300 receives the emergency situation occurrence signal from the controller 202 of the security unit 200, and informs a staff member 210 located closest to an occurrence area of the emergency situation so that the staff member may intercept.

When a user of the mobile terminal 100 is threatened by a criminal within a security area monitored by one or more security units 200, the user informs the controller 102 that an emergency situation has occurred by pressing the emergency key 104.

The controller 102 of the mobile terminal determines whether the pressed key is the emergency key 104, and when it is determined that the pressed key is the emergency key 106, generates an emergency signal and informs the short range communication unit 104 of a corresponding emergency signal. The emergency signal may include user information or may not include the user information but inform only of the emergency situation. The mobile terminal 100 may include a location determination unit (not shown), such as a Global Positioning System (GPS) unit. When the mobile terminal 100 includes a location determination unit, location information corresponding to the location of the mobile terminal 100 may be included in the emergency signal. The short range communication unit 104 transmits the emergency signal informed by the controller 102 of the mobile terminal to the neighboring security unit 200.

A mechanism for preventing a malfunction by a user in the mobile terminal 100 is required. There may exist various methods for preventing a malfunction. As a representative method, a method of providing a locking and releasing of a hot key in a hardware manner, or a method of using a simple key combination may be used. For example, the method may be realized by pressing a numerical key “1” several times and then pressing a relevant hot key. Also, in the case where an emergency signal generation hot key is not provided, this function may be executed through a combination of conventional keys. However, the combination of the keys should be simple. The key combination may be determined by a manufacturer of the mobile terminal 100 or may be set by a user of the mobile terminal 100.

The short range communication may be Bluetooth, Zigbee, Near Field Communication (NFC), Wireless Local Area Network (WLAN), Wireless Fidelity (WiFi), or the like. Regarding the short range communication, there is no limitation in a communication scheme.

An emergency signal sent from the short range communication unit 106 of the mobile terminal is received by the emergency signal receiver 204 of the neighboring security unit 200. The received emergency signal is transferred to the controller 202 of the security unit 200. The controller 202 of the security unit 200 determines whether the received signal is an emergency signal. When the controller 202 determines that the received signal is the emergency signal, the controller 202 operates alarm apparatuses such as the flashing light 208 and the siren 206. The security unit 200 may include a location determination unit (not shown) for determining the location of the mobile terminal 100 from the received emergency signal. The controller 202 generates an emergency situation occurrence signal and informs the security center 300 of the security company of the occurrence of the emergency situation together with the alarm operation. In the case where the emergency signal received from the mobile terminal 100 includes user information, the controller 202 informs the security center 300 of the security company of the user information when informing of the occurrence of the emergency situation.

The security center 300 determines the area where the emergency situation is occurring and selects a staff member 210 located closest to an area of occurrence of the emergency situation. The security center 300 of the security company may determine the area where the emergency situation is occurring based on information received from the structure 200 of the security company. Alternatively, the security center 300 of the security company may determine the area where the emergency situation is occurring based on its knowledge of the location of the structure 200 of the security company. Since, the emergency signal sent from the mobile terminal 100 to the structure 200 of the security company is via short range communication, the mobile terminal should be within a certain proximity to structure 200 of the security company. Further, the security center 300 may include a staff member locating unit for determining the location of one or more staff members. The security center 300 informs the selected staff member of the emergency situation so that the staff member may move to the area where the emergency signal was generated. Further, the security center 300 may inform a police station or a fire station of occurrence of the emergency situation. The security center 300 may monitor one or more security units 200.

Therefore, an exemplary embodiment of the present invention may prevent a crime even in a crime dead zone of a department store or a discount store by operating a neighboring flashing light or an alarm sound such as a siren when an emergency signal of a mobile terminal is sent.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for transmitting and responding to an emergency signal, the method comprising:
determining, by the mobile terminal, whether an emergency key that indicates the occurrence of an emergency situation is pressed;
when it is determined that the emergency key is pressed, transmitting, by the mobile terminal, an emergency signal to a neighboring security unit via short range communication;
receiving, by the neighboring security unit, the emergency signal from the mobile terminal via the short range communication; and
operating an alarm apparatus according to the received emergency signal.

2. The method of claim 1, further comprising:
transmitting, by the neighboring security unit, an emergency situation occurrence signal, corresponding to the emergency signal received from the mobile terminal, to a security center; and
informing, by the security center, a staff member located near an occurrence area of the emergency situation.

3. The method of claim 2, wherein the emergency situation occurrence signal includes user information.

4. The method of claim 2, wherein the emergency situation occurrence signal includes location information.

5. The method of claim 2, further comprising, informing, by the security center, a police station or a fire station of occurrence of the emergency situation.

6. The method of claim 1, wherein the operating of the alarm apparatus comprises operating at least one of a flashing light and a siren.

7. The method of claim 1, wherein the emergency signal includes user information.

8. The method of claim 1, wherein the emergency signal includes location information.

9. The method of claim 1, wherein the short range communication comprises one of Bluetooth, Zigbee, Near Field Communication (NFC), Wireless Local Area Network (WLAN), and Wireless Fidelity (WiFi).

10. A system for transmitting and responding to an emergency signal, the system comprising:
a mobile terminal comprising:
a key for indicating the occurrence of an emergency situation when it is pressed;
a controller for determining if the key is pressed, and if it is determined that the key is pressed, for generating an emergency signal; and
a short range communication unit for transmitting the emergency signal to a security unit; and
the security unit comprising:
a short range communication unit for receiving the emergency signal transmitted from the mobile terminal;
a controller for operating an alarm apparatus according to the received emergency signal; and
the alarm apparatus for executing an alarm operation.

11. The system of claim 10, wherein the controller generates an emergency situation occurrence signal according to the received emergency signal and transmits the emergency situation occurrence signal to a security center, the system further comprising:
the security center for receiving the emergency situation occurrence signal from the security unit, for selecting a staff member located near an occurrence area of the emergency situation, and for informing the staff member of the occurrence of the emergency situation.

12. The system of claim 11, wherein the emergency situation occurrence signal includes user information.

13. The system of claim 11, wherein the emergency situation occurrence signal includes location information.

14. The system of claim 11, wherein the security center informs a police station or a fire station of occurrence of the emergency situation.

15. The system of claim 10, wherein the emergency signal includes user information.

16. The system of claim 10, wherein the emergency signal includes location information.

17. The system of claim 10, wherein the short range communication unit comprises one of Bluetooth, Zigbee, Near Field Communication (NFC), Wireless Local Area Network (WLAN), and Wireless Fidelity (WiFi).
